(19) United States
(12) Patent Application Publication
(10) Pub. No.: US 2021/0139705 A1
(43) Pub. Date: May 13, 2021

(54) New Asphalt Mixtures

(71) Applicant: TAAVURA HOLDINGS LTD, Ramla (IL)

(72) Inventor: Zeev Livnat, Ramla (IL)

(21) Appl. No.: 17/053,101

(22) PCT Filed: May 15, 2019
(86) PCT No.: PCT/IL2019/050550

§ 371 Date: Nov. 5, 2020

(30) Foreign Application Priority Data
May 21, 2018 (IL) 259500

(51) Int. Cl. C08L 95/00; C08L 19/00

(52) U.S. Cl. CPC C08L 95/00; C08K 3/00; C08L 19/00

(57) ABSTRACT

The invention provides a new additive for replacing a part of asphalt in road construction mixtures, while enhancing their capability to withstand severe traffic and weather stresses in a cost-effective and environmentally friendly way.

### FIELD OF THE INVENTION

The present invention relates to new compositions for use in construction, particularly in roads construction. More particularly, the invention provides compositions for admixing to asphalt and mixtures thereof, as well as a method of producing them.

### BACKGROUND OF THE INVENTION

Bitumen is used worldwide as a binder in asphalt mixtures including mineral aggregates of different sizes, shapes and chemical nature. These asphalt mixtures are particularly used for construction and maintenance of roads, pavements, and other rolling surfaces. After laying, the asphalt mixtures are exposed to a wide variation of environmental conditions, and the properties of the bitumen-based binders at high and low temperatures are of a decisive importance. At low temperatures, bituminous materials can become brittle, leading to fissures and cracks, at higher temperatures the viscosity of the bitumen binders decreases, leading for example to rutting of roads. Resistance to fatigue and impact, and the adherence of bitumen binder to the aggregates in the asphalt mixtures are also of particular importance for road construction.

The mechanical capabilities of the bituminous binder to withstand increasingly severe stresses caused by traffic have been improved by adding polymer modifiers aiming at improved elasticity and resistance to fatigue. The modifiers have included styrene-butadiene-styrene block-copolymers, rubbers, and other materials. Recent increased demands on environmental protection have led to employing granulated recycled tires. It is therefore an object of this invention to provide a system for improving asphalt-comprising construction mixtures, particularly road construction mixtures.

It is another object of this invention to provide a method for improving asphalt-comprising road construction mixtures in a cost-effective way, resulting in improved performance grade.

It is still another object of this invention to improve the bitumen-containing construction materials by incorporating an additive, in a cost-effective and environmentally friendly way.

It is a further object of the invention to provide a new additive for asphalt mixtures, which would improve their performance, while utilizing waste components.

Other objects and advantages of present invention will appear as the description proceeds.

### SUMMARY OF THE INVENTION

This invention provides an additive for replacing a part of bitumen in bitumen construction mixtures and for improving said construction mixtures, comprising i) 50-70 wt % vulcanized rubber; ii) 15-25 wt % bitumen; and iii) 15-25 wt % mineral powder. The terms bitumen and asphalt are used interchangeably. Said powder is preferably a fossil fuel ash, more preferably a shale ash.

The invention relates to a method for manufacturing an additive for replacing a part of bitumen in bitumen construction mixtures and for improving said construction mixtures, comprising i) loading particles of vulcanized rubber into a reactor and heating till a temperature of 150-180° C. in the whole reactor volume is achieved; ii) loading bitumen to said rubber and heating till a temperature of 150-180° C. in the whole reactor volume is achieved; and iii) loading a mineral powder to said mixture of rubber and bitumen, and heating till a temperature of 150-180° C. in the whole reactor volume is achieved; wherein the rubber, bitumen, and mineral powder are in the amounts of 50-70 wt %, 15-25 wt %, and 15-25 wt %, respectively, thereby obtaining granules of said additive. The method comprises homogenizing the components. The method comprises a step of cooling and granulation, wherein granules of an average size of up to 5 mm, such as up to 4 mm, or up to 3 mm or up to 2 mm or up to 1 mm are obtained. Said powder preferably comprises fuel ash, such as oil shale ash. The components are heated in one embodiment at 160-170° C., homogenized, and cooled. In one embodiment, the method further comprises a step of admixing calcium hydroxide, after said step iii, in an amount of 3-12 wt % of the mixture in step iii, such as in an amount of 5-10 wt % of the mixture in step iii. Said hydroxide prevents sticking the granules to each other, but improves also other properties of the granules.

The invention provides a system and a method of improving asphalt-comprising construction mixtures, particularly road construction mixtures, comprising replacing a part of said asphalt with an additive comprising 50-70 wt % vulcanized rubber; 15-25 wt % bitumen; and 15-25 wt % mineral powder, preferably shale ash powder. Said replaced part is usually 10-30 wt % of said asphalt to be replaced in the system and method of the invention. Said additive improves performance grading of said road construction mixture by at least 10 PG points. The PG point corresponds to a maximal temperature at which said construction material can be used without substantial melting of the components, which melting precludes the expected utilization of the material. The system of the invention improves, in one embodiment, the performance grading of the construction material from 75 to 80 PG points, and even to 85 PG points, and in some embodiments even to 90 PG points or more. The system and method of the invention replaces 20 wt % of said asphalt in one embodiment, while improving performance grading of said road construction mixture by at least 20 PG points.

### BRIEF DESCRIPTION OF THE DRAWINGS

The above and other characteristics and advantages of the invention will be more readily apparent through the following examples, and with reference to the appended drawings, wherein:

FIG. 1. the upper graph shows the effect of the additive according to the invention on the performance grade, % bitumen being replaced is plotted against the PG points for two types of the additives; the lower graph shows the extent of construction material degradation (rutting model) during 10,000 use cycles for two materials with an additive of the invention and one comparison material;

FIG. 2. shows photos of construction materials after model degradation (rutting model) for a material with an additive of the invention and one comparison material;

FIG. 3. is a table showing the composition of one exemplary shale ash to be possibly used in the additive of the invention; and

FIG. 4. schematically shows a manufacturing process of some of construction materials comprising an additive of the invention.

### DETAILED DESCRIPTION OF THE INVENTION

It has now been surprisingly found that a mixture of vulcanized rubber with bitumen is a particularly efficient and advantageous additive to road asphalt, if containing an inorganic component comprising fossil fuel ash in an amount of 5 to 30 wt %, particularly oil shale ash in an amount of 15 to 25 wt %.

In one embodiment, fine crumb rubber (50-60%), soft bitumen (15-25 %), and a mineral component, preferably shale ash (15-25 %) are mixed, while employing a short-time hot blending, followed by granulation to form a dry granulated activated rubber to be added to any type of hot mix asphalt (HMA), such as dense, open graded, SMA, etc., for replacing a part of the asphalt binder (bitumen) at different proportions.

The additive of the invention achieves a desired bitumen modification, and also asphalt mixtures improvement. The additive may be produced, for example, in a production unit which has a compact container placed close to the crumb rubber supplier, or to customer's HMA plant, the production unit being equipped with tanks for bitumen, without requiring special tanks or silos. Dry raw materials can be stored in big bags to be fed into the process via loading and weighing hoppers. In contrast to usual field blend rubber binders requiring constant heating or complicated machinery at site, the additive can be stored and transported in big-bags similarly as crumb rubber. In one embodiment of the invention, said advantageous additive is added directly to the pug mill or dryer drum, right after the bitumen spraying, using existing feeders (i.e. fiber feeders for SMA mixes, etc., FIG. 4). The additive may be fed directly into the pug-mill on HMA plant using standard pneumatic feeding equipment for loading of granulated materials and can be supplied by HMA plant producer, combining the advantages of “dry” and “wet” method of feeding.

The system of the invention provides i) simple, safe and ecologically friendly storing of materials, feeding and application at HMA plant; ii) controlled degree of bitumen modification (depends on % of the additive replacing bitumen) adoptable for any type of produced mix; iii) production of resulting rubber binder directly in pugmill, which matures during transportation before laying, precluding degradations due to long storing and transportation times (as for usual terminal blends) and requirements for expensive and bulky CR-bitumen mixing installations on site (as for field blend), and avoiding extremely difficult pumping; iv) new unique types of mixes with unique properties with highest possible rubber content.

The additive of the invention significantly effects the basic properties of regular bitumen, and expands the possibilities, confirmed by standards methods (viscosity, R&B, penetration, resilience) as well as by dynamic shear rheometer (DSR) AASHTO T 315, rolling thin film oven (RTFO) AASHTO T 240, pressure aging vessel (PAV) AASHTO R 28, bending beam rheometer (BBR), AASHTO T 313, multi stress creep recovery (MSCR) AASHTO TP 70, etc. The additive of the invention can provide an equally positive effect for all types of bitumens of different grades from various producers. It can replace from 10% (start of the significant effect) up to 40% of bitumen in road mixes, depending on type of the mix (Dense, Open Graded, GAP-graded, SMA, porous).

In some embodiments, the additive content for different types of HMA mixes can be In Dense Graded mixes 15% to 20% of the combined binder, which corresponds to about 1% of the total mix weight. In SMA mixes, 30% of the combined binder may be used, corresponding to 1.5% of the total mix weight.

On the basis of extensive testing program results with various materials (aggregates and bitumens), the following improvement of mixture properties can be achieved in comparison with known binders:

a) improvements in Dense Graded mixes: i) rutting resistance increased up to 30%-50% (for some materials tested up to 100% and more), ii) fatigue resistance can be increased up to 50%-100%, iii) other parameters are comparable, or better, iv) possible to use lower quality and cheaper bitumen (modification at site);

b) improvements in SMA mixes: i) rutting resistance increased up to 50% (for some materials tested up to 150% and more), ii) fatigue resistance can be increased up to 100% and more, iii) draindown can be reduced to 0; no cellulose or other additives are needed, iv) no need in SBS-modified bitumen, possible to use cheaper bitumen (modification at site).

Among advantages of the additive of the invention are:

a) advantages as a bitumen modifier: i) modification of low quality/normal bitumen for use in any type of mixtures, expensive modified bitumen not required, ii) positive and negative PG-grade limits extension, iii) variable degree of modification for different mixtures (controlled PG-grading), iv) improved bitumen resilience and adhesion;

b) advantages in asphalt mixes: i) improved rutting resistance, ii) improved fatigue resistance, better elastic properties (elastic deformation recovery), iii) no other additives required, iv) longer road durability, less maintenance costs, v) better anti-skidding, anti-icing surface properties, silent asphalt—low noise roads.

Further advantages include:

a) advantages in asphalt mixes production: i) dry process (direct feeding into pugmill), ii) no need for expensive blenders (SBS, or AR), iii) no other additives required (SBS, fibers, etc.), iv) standard cellulose, or powder material pneumatic feeders can be used (equipment to be checked at site), v) less energy consumption at asphalt plant vs AR wet technology, v) easy to handle (transporting, storing, feeding);

b) advantages in safety and environment: i) utilization of used tires (no burning, no air pollution, no CO2 emission), clean production technology (no fumes, no pollution), safe to transport, store and feed.

The invention thus relates to a system comprising utilizing waste tire scraps and waste fuel ash for manufacturing an additive for replacing a part of bitumen in bitumen construction mixtures and for improving said construction mixtures. The vulcanized rubber, bitumen and inorganic powder are heated in a simple process, providing granules of the additive, to be easily handled, stored and used; in one embodiment, the granules are coated with calcium hydroxide which was found by the inventors to further improve the granules properties.

While the invention has been described using some specific examples, many modifications and variations are possible. It is therefore understood that the invention is not intended to be limited in any way, other than by the scope of the appended claims.

1. An additive for replacing a part of bitumen in bitumen construction mixtures and for improving said construction mixtures, comprising
i) 50-70 wt % vulcanized rubber;
ii) 15-25 wt % bitumen; and
iii) 15-25 wt % mineral powder.

2. The additive of claim 1, wherein said powder is a fuel ash.

3. The additive of claim 1, wherein said powder is a shale ash.

4. A method for manufacturing an additive for replacing a part of bitumen in bitumen construction mixtures and for improving said construction mixtures, comprising
i) loading particles of vulcanized rubber into a reactor and heating till a temperature of 150-180° C. in the whole reactor volume is achieved;
ii) loading bitumen to said rubber and heating till a temperature of 150-180° C. in the whole reactor volume is achieved; and
iii) loading a mineral powder to said mixture of rubber and bitumen, and heating till a temperature of 150-180° C. in the whole reactor volume is achieved;
wherein the rubber, bitumen, and mineral powder are in the amounts of 50-70 wt %, 15-25 wt %, and 15-25 wt %, respectively, thereby obtaining granules of said additive.

5. The method of claim 4, comprising mixing the components.

6. The method of claim 4, comprising a step of cooling and granulation, wherein granules of an average size of up to 3 mm.

7. The method of claim 4, wherein said powder comprises fuel ash.

8. The method of claim 4, wherein said powder comprises shale ash.

9. The method of claim 4, wherein said temperature is 160-170° C.

10. The method of claim 4, wherein said step iii is followed by admixing calcium hydroxide in an amount of 3-12 wt % of the mixture in step iii.

11. The method of claim 4, wherein said step iii is followed by admixing calcium hydroxide in an amount of 5-10 wt % of the mixture in step iii, said hydroxide coating said granules.

12. A system of improving asphalt-comprising construction mixtures, comprising replacing a part of said asphalt with an additive comprising 50-70 wt % vulcanized rubber; 15-25 wt % bitumen; and 15-25 wt % mineral powder, preferably shale ash powder.

13. The system of claim 12, wherein said replaced part constitutes 10-30 wt % of the desired bitumen.

14. The system of claim 17, wherein said additive improves performance grading of said road construction mixture by at least 10 PG points.

15. The system of claim 17, wherein said additive replaces 20 wt % of said asphalt and improves performance grading of said road construction mixture by at least 20 PG points.

16. The method of claim 4, comprising a step of cooling and granulation, wherein granules of an average size of up to 2 mm are obtained.

17. The system of claim 12, wherein the asphalt-comprising construction mixtures are road construction mixtures.
